(19) United States
(12) Patent Application Publication
(10) Pub. No.: US 2002/0101065 A1
(43) Pub. Date: Aug. 1, 2002

(54) Wheeled, portable, collapsible athletic equipment carrier

(76) Inventors: Jim McCollum, Goodman, MO (US); Judy McCollum, Goodman, MO (US)

Correspondence Address: Law Offices of John D. Gugliotta, P.E., Esq., 202 Delaware Building, 137 South Main Street, Akron, OH, 44308, US

(21) Appl. No.: 09/774,962

(22) Filed: Jan. 31, 2001

(51) Int. Cl. B62B 7/06

(52) U.S. Cl. 280/655; 280/47.315

(57) ABSTRACT

A wheeled, portable, collapsible athletic equipment carrier is provided. A two-wheeled cart is incorporated in an athletic bag for aiding in the carrying of athletic equipment from one's vehicle to the playing area.

### RELATED APPLICATIONS

The present invention was first described in Disclosure Document No. 475,655 filed on Jun. 16, 2000. There are no previously filed, nor currently any co-pending applications, anywhere in the world.

### BACKGROUND OF THE INVENTION

1. Field of the Invention

The present invention relates generally to sports equipment carriers and, more particularly, to a wheeled, portable, collapsible athletic equipment carrier.

2. Description of the Related Art

There are many people who are active in a wide variety of team sports, such as baseball, soccer, softball, football and the like. While the health advantages associated with such participation and exercise are beneficial, the automobiles used by these people end up looking like a sport locker. Not only do all the balls, bats, gloves, safety equipment, training aids, and the like end up rolling around in the trunk or back end of a pickup truck, these items are also hard to find when needed. Additionally, when these items are carried to the playing field, several trips must be made to accommodate all of the equipment. If a duffel bag is used, the resulting total weight and size may make the bag almost impossible to move, especially for people who are of a small stature. These problems are compounded for those who are coaches of such teams and are expected to bring the equipment for the entire team.

Accordingly, there exists a need for a means by which sporting equipment can be transported from an automobile or pickup truck, to a playing field and back again with relative ease, while organizing such equipment as well. The development of the wheeled, portable, collapsible athletic equipment carrier fulfills this need.

A search of the prior art did not disclose any patents that read directly on the claims of the instant invention; however, the following references were considered related. The following patents disclose a golf bag having retractable wheels and a handle: U.S. Pat. No. 6,056,301 issued in the name of Berliner et al.; U.S. Pat. No. 5,478,097 issued in the name of Forma; and U.S. Pat. No. 4,911,465 issued in the name of Hauer.

The following patents describe a wheeled golf bag support base and handle: U.S. Pat. No. 5,924,709 issued in the name of Yang; and U.S. Pat. No. 5,480,178 issued in the name of Suk.

U.S. Pat. No. 6,068,270 issued in the name of Kim discloses a detachable cart for carrying a golf bag.

U.S. Pat. No. 5,860,519 issued in the name of Meyer et al. describes a sports equipment carrier with wheels and a strap.

U.S. Pat. No. 5,265,894 issued in the name of Dunn discloses a wheeled cover for a golf bag or the like.

U.S. Pat. No. 5,112,068 issued in the name of Liao et al. describes a convertible golf bag and cart.

U.S. Pat. No. 3,953,046 issued in the name of Johansson discloses a wheeled, folding sport stroller.

Consequently, a need has been felt for providing a means which allows anyone to transport a large amount of sporting equipment to and from the playing field in a manner which is quick, easy and efficient.

### SUMMARY OF THE INVENTION

Therefore, it is an object of the present invention to provide a sports equipment carrier used to carry sports equipment from a car or pickup trick to a playing field.

It is another object of the present invention to provide a sports equipment carrier which can carry baseballs, gloves, helmets, bats, soccer balls, footballs, protective gear, and similar items all at once.

It is still another object of the present invention to provide a sports equipment carrier which resembles a golf bag on a wheeled cart.

It is still another object of the present invention to provide a sports equipment carrier with wheels being made of rubber for durability.

It is still another object of the present invention to provide a sports equipment carrier with wheels having a large diameter so as to easily roll over rough terrain.

It is another object of the present invention to provide a sports equipment carrier with wheels having ball bearings for smooth operation.

It is another object of the present invention to provide a wheeled sports equipment carrier having a large bag for carrying large items.

It is another object of the present invention to provide a wheeled sports equipment carrier having a large bag which is perfect for inflated balls, helmets, bats, and similar items.

It is another object of the present invention to provide wheeled sports equipment carrier having a large bag incorporating an air pumping means for inflating balls and similar items.

It is another object of the present invention to provide a wheeled sports equipment carrier having a large bag with a large opening which is opened and closed with a Velcro® flap.

It is another object of the present invention to provide a wheeled sports equipment carrier having a pair of pockets which are perfect for containing smaller items such as baseballs, batting gloves, sports drinks, and other similar articles.

It is another object of the present invention to provide a wheeled sports equipment carrier having a pair of pockets which are opened and closed with Velcro® flaps or zippers.

It is another object of the present invention to provide a wheeled sports equipment carrier having a pair of pockets which prevent small items getting lost with larger items.

It is another object of the present invention to provide a wheeled sports equipment carrier which is foldable in design; thus allowing for the neat, orderly storage and transportation within the trunk of a vehicle or pickup truck.

Briefly described according to one embodiment of the present invention, a wheeled, portable, collapsible athletic equipment carrier is provided for aiding in the carrying of sporting equipment from one's vehicle to the playing area. The invention forms a bag with a rolling stand upon first observation, with a slightly larger bag having a large opening formed at a top thereof, an elongated insert opening in a front thereof, and a pair of pockets located on the exterior thereof. All openings are opened and closed via Velcro® flaps or zippers. The invention is intended for use with sports such as baseball, softball, soccer, basketball, football, and the like. Large items such as inflated balls, bats, helmets, catching gear and the like would be stored in the bag while smaller items such as baseball, softballs, batting gloves and the like would be stored in the smaller pockets. Optionally provided is an air pumping means for easy access when inflating soccer balls, footballs, or basketballs. A pair of rubber wheels, each with ball bearings, would allow easy transportation from a motor vehicle to a baseball field, soccer field, or to the field or playing area of whatever sport is being played.

The use of the present invention provides a means for allowing anyone to transport a large amount of sporting equipment to and from the playing field in a manner which is quick, easy and efficient.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a wheeled, portable, collapsible athletic equipment carrier according to the preferred embodiment of the present invention;

FIG. 2 is a perspective view of the wheeled, portable, collapsible athletic equipment carrier shown with the athletic bag removed according to the preferred embodiment of the present invention;

FIG. 3 is a front side elevational view of the athletic bag shown with flaps in an open position;

FIG. 4 is a rear side exploded view of the athletic bag according to the preferred embodiment of the present invention;

FIG. 5 is a rear end elevational view of the wheels shown pivoted in an inward direction; and

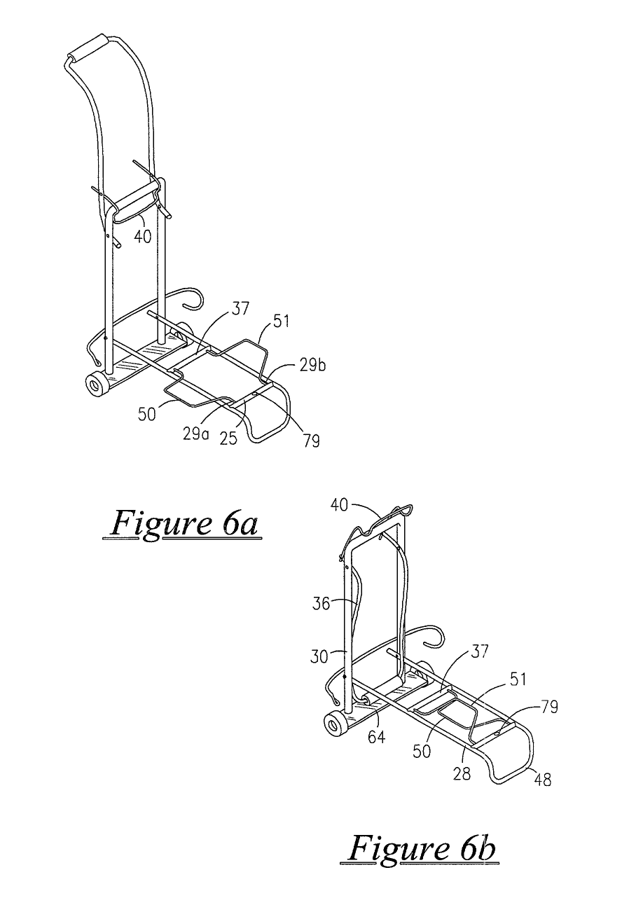

FIGS. 6a-6d show an alternate embodiment of the present invention.

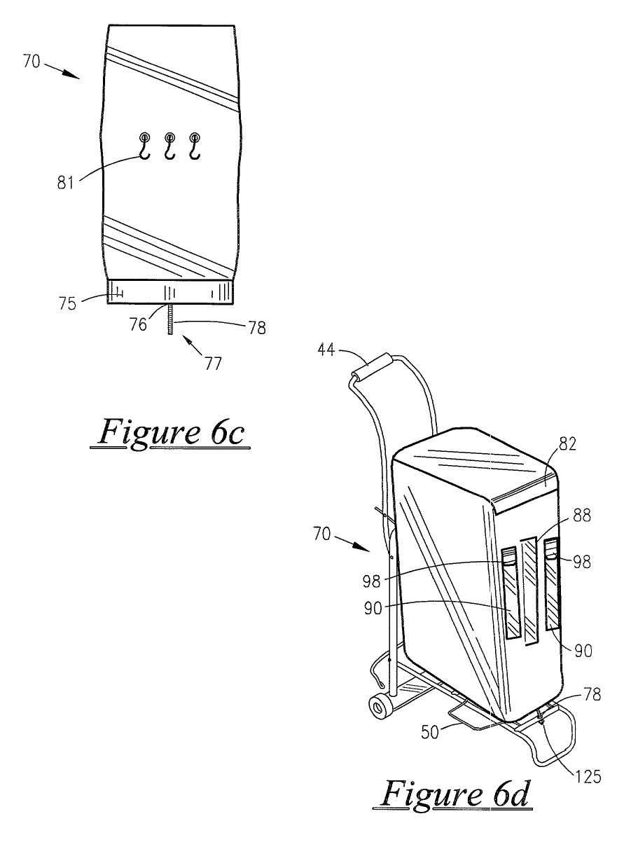

### DESCRIPTION OF THE PREFERRED EMBODIMENT

1. Detailed Description of the Figures

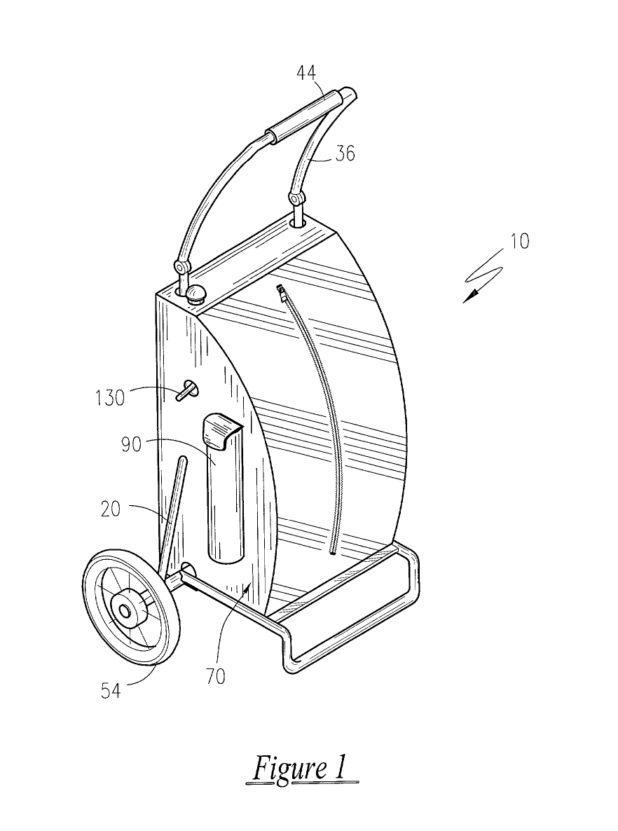

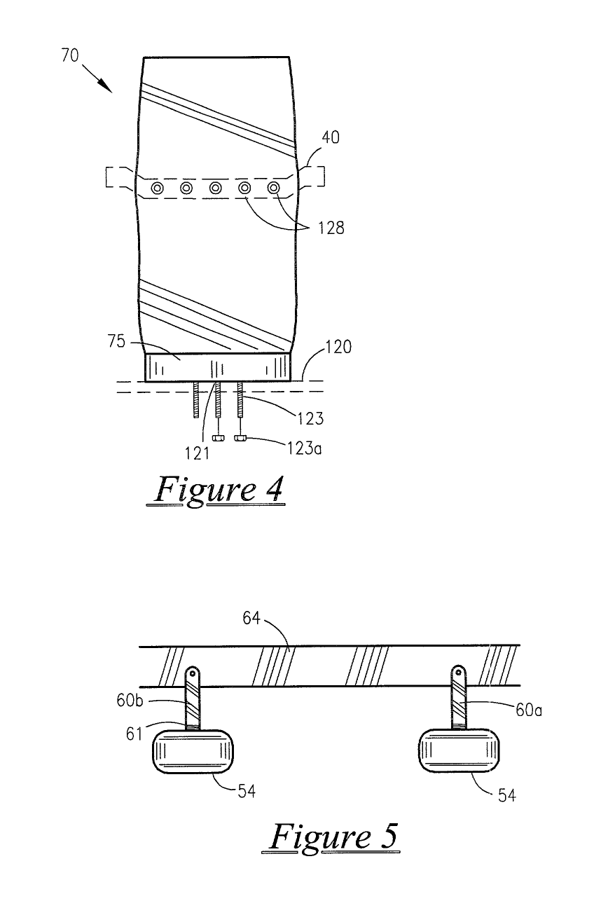

Referring now to FIGS. 1-4, a wheeled, portable, collapsible athletic equipment carrier 10 is shown, according to the present invention, comprised of a two-wheeled cart 20 incorporated within an otherwise conventional athletic bag 70 for aiding in the carrying of athletic equipment from one's vehicle to the playing area.

The cart 20 is comprised of a main frame 22 having an anterior end opposite a posterior end. The main frame 22 is preferably constructed of rigid, high-strength aluminum, thereby providing a device being not only lightweight, but high in strength. The main frame 22 includes a hollow, tubular base member 28 forming a U-shape which serves as a base 29 upon which an equipment-filled athletic bag 70 can be supported.

In order to maintain the device in an upright position, a support stand 48 having an elongated, hollow, cylindrical U-shaped configuration is welded to lower external circumferential sidewalls of the U-shaped portion of the base member 28 at corners 29a, 29b thereof. It is envisioned that the support stand 48 measures approximately 10 inches in width.

A linearly elongated, hollow, tubular base support member 32 is welded perpendicularly at ends between inside external circumferential sidewalls of the posterior end of the main frame 22 so as to provide structural stability thereto.

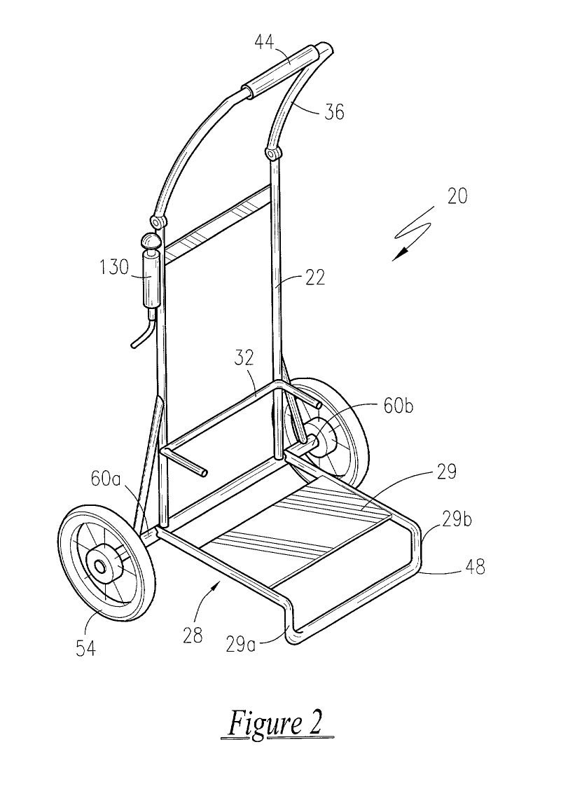

A hand-operated inflating pump 130 (shown in FIGS. 1 and 2) is securely attached to an outer, elongated sidewall of the upright member of the frame 22 in a linear fashion so as to provide a means for inflating basketballs, soccer balls, footballs or other sports balls requiring inflation. The inflating pump 130 includes an air dispensing tube with an inflating stem attached to an end thereof.

An elongated, hollow, tubular handle 36 formed of a U-shape is pivotally mounted to inside external circumferential sidewalls of the main frame 22 at the anterior end thereof. Ends opposite the U-shaped portion of the handle 36 are of an arcuate configuration and extend to their pivotal attachment thereto. The pivotal attachment of the handle 36 to the main frame 22 facilitates a folding action of the handle 36. The handle 36 is folded in a backwards direction toward a rear side of the main frame 22 in an overlapping manner to a flat position, thereby providing a foldable device which is easily transportable.

The U-shaped portion of the handle 36 at the anterior end of the main frame 22 is enclosed within spongy, compressible, rubber material 44 so as to provide user comfort. The rubber material 44 measures approximately 8 inches in length.

The main frame 22 further includes rubber wheels 54 which terminate in a pivotally mounted axle 60a, 60b. To facilitate frictionless rotation of the wheels 54 about their respective pivotally mounted axle 60a, 60b, bearings are mounted at a coupling point of each axle 60a, 60b. It is envisioned that the wheels 54 have a diameter measuring approximately 8 inches so as to provide less initial shock when rolling over uneven terrain, bumps, ruts or other recessions.

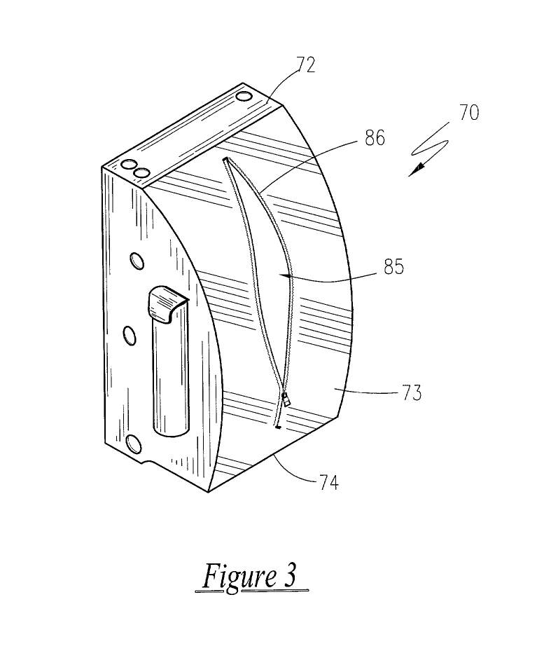

Referring now to FIGS. 3, an athletic bag 70 for containing athletic equipment is comprised of a generally vertically elongated configuration having a top end 72 opposite a bottom end 74 and is fabricated of a weatherproof, flexible, heavy fabric of nylon or vinyl. The bottom end 74 rests against the base 29 such as to form a bag mounting platform to serve as a base upon which the base 75 of the athletic bag 70 is permanently attached. The base 75 of the athletic bag 70 is permanently attached via a plurality of bolts 123 driven through apertures 121 in the base 75 protruding therethrough and penetrating holes 122 drilled in the bag mounting platform 120 with nuts 123a tightened thereon. A rear side of the athletic bag 70 along a linearly elongated centerline thereof is permanently attached to the brace 40 by a plurality of linearly aligned rivots 128. The athletic bag 70 includes a large opening 80 formed at the top end 72 thereof and is opened and closed with the use of a flap 82 formed at the top end 72 thereof. A wide, linear strip of Velcro® material 105 is sewn to an underside of the flap 82, and along an outer surface 73 of the top end 72 on a front side of the athletic bag 70, so as to facilitate both the opening and closing of the large opening 80.

A large cavity 85 with a longitudinally extending insert opening 86 is formed on an outer surface 73 on the front side of the athletic bag 70 between a pair of ball-receiving cylinders 90 (to be describe in greater detail below). The insert opening 86 can be opened and closed with the use of a linearly elongated flap 88 formed along the outer surface 73 of the athletic bag 70. A wide, linear strip of Velcro® material is sewn to an underside of the flap 88, and along the outer surface of the athletic bag 70, so as to facilitate both the opening and closing of the insert opening 86. It is envisioned that the athletic bag 70 measures approximately 40 inches in length. It is further envisioned that the athletic bag 70 be available in multiple colors for corresponding with team colors.

Each of the pair of ball-receiving cylinders 90 are suitable attached to the front side of the athletic bag 70, and are positioned so as to be on opposed lateral sides of the insert opening 86 of the large cavity 85. The ball-receiving cylinders 90 are fabricated of the weatherproof, flexible, heavy fabric of nylon or vinyl from which the athletic bag 70 is formed. Each ball-receiving cylinder 90 has a measured diameter suitable for accommodating softballs and/or baseballs. The perimeter measurements of each ball-receiving cylinder 90 extends uniformly through the depth thereof. It is envisioned that each ball-receiving cylinder 90 has a length suitable for snugly retaining five softballs therein. However, the length of each ball-receiving cylinder 90 is by no means limiting and is meant only as a suggestion.

An insert opening 96 is formed at a top portion 97 of each ball-receiving cylinder 90, and can be opened and closed with the use of a flap 98 formed at the top portion 97 thereof. A thin, linear strip of Velcro® material 105 is sewn to an underside of each flap 98, and along an outer surface 99 of the ball-receiving cylinder 90 just below the insert opening 96 formed therein, so as to facilitate both the opening and closing of the insert opening 96.

The wheeled, portable, collapsible athletic equipment carrier 10 is designed and configured so as to securely accommodate and transport baseballs, softballs, helmets, bats, soccer balls, basketballs, footballs, rackets, protective gear, and other similar athletic equipment to a playing area. In addition, being collapsible in design with respect to the folding handle 36, and the rotating wheels 54, the wheeled, portable, collapsible athletic equipment carrier 10 allows for the neat, orderly storage and transportation thereof within the trunk of a vehicle.

2. Operation of the Preferred Embodiment

To use the present invention, a user fills the athletic bag 70 through a large opening 80 with large sports equipment such as basketballs and/or soccer balls and secures the contents therein by closing flap 82. In the event the user desires to carry softballs and/or baseballs, a pair of ball-receiving cylinders 90 are located along the front side of the athletic bag 70 for securely accommodating the baseballs therein. After having placed the baseballs through each insert opening 96 of each respective ball-receiving cylinder 90, each insert opening 96 can be opened and closed with the use of a flap 98 formed at the top portion 97 thereof, thereby securely accommodating the baseballs therein. Additional desired sports equipment may be placed by the user within a large cavity 85 through its insert opening 86 formed on an outer surface 73 on the front side of the athletic bag 70. The insert opening 86 can be opened and closed with the use of a flap 88, thereby securely accommodating the sports equipment therein. Next, the user folds the handle 36 in a backwards direction toward a rear side of the upright member 30 in an overlapping manner to a flat position. The wheels are then pivoted inward, thereby providing a foldable device which is easily stored within a trunk of a vehicle and thus easily transportable. After arriving at a desired playing area, the present invention is removed from the trunk of a vehicle, the handle 36 is folded in an upwards direction to an upright position, and the wheels 54 are pivoted outward. The user then grasps the rubber material 44 of the handle 36 with his hands and the wheeled, portable, collapsible athletic equipment carrier 10 is transported to the desired playing area.

The use of the present invention provides a means for allowing anyone to transport a large amount of sporting equipment to and from the playing field in a manner which is quick, easy and efficient.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. Therefore, the scope of the invention is to be broadly limited only by the following claims.

What is claimed is:

1. A wheeled, portable, collapsible athletic equipment carrier comprising:
a two-wheeled cart; and
an athletic bag incorporating said cart for aiding in the carrying of athletic equipment from one's vehicle to the playing area.

2. The equipment carrier of claim 1, wherein said cart comprises:
a main frame having an anterior end opposite a posterior end and including a hollow, tubular base member forming a U-shape which serves as a base upon which said athletic bag can be supported.

3. The equipment carrier of claim 2, wherein said cart further comprises:
a support stand having an elongated, hollow, cylindrical U-shaped configuration affixed to lower external circumferential sidewalls of the U-shaped portion of the base member at corners so as to provide structural stability thereto.

4. The equipment carrier of claim 1, further comprising a hand-operated inflating pump securely attached to an outer, elongated sidewall of the upright member of the frame in a linear fashion so as to provide a means for inflating sports balls requiring inflation.

5. The equipment carrier of claim 2, wherein said cart further an elongated, hollow, tubular handle formed of a U-shape and pivotally mounted to inside external circumferential sidewalls of said main frame at the anterior end thereof.

6. The equipment carrier of claim 1, wherein said athletic bag comprises a generally vertically elongated configuration having a top end opposite a bottom end and is fabricated of a weatherproof, flexible, heavy fabric.

7. The equipment carrier of claim 1, wherein said bottom end rests against the base such as to form a bag mounting platform to serve as a base upon which the base of the athletic bag is permanently attached.

8. The equipment carrier of claim 1, further comprising a pair of ball-receiving cylinders attached to the front side of the athletic bag, each said ball-receiving cylinder has a measured diameter suitable for accommodating softballs and/or baseballs.
